(19) United States
(12) Patent Application Publication
(10) Pub. No.: US 2014/0103630 A1
(43) Pub. Date: Apr. 17, 2014

(54) PRINTED LEAF, BOUND LEAF, LEAF PROVIDING METHOD, FOLDING PRINTED LEAF, AND BOOK

(71) Applicant: Yutaka Hirahara, Osaka-shi (JP)

(72) Inventor: Yutaka Hirahara, Osaka-shi (JP)

(73) Assignee: CALENDAR KOKOKU CO., LTD., Osaka-shi, Osaka (JP)

(21) Appl. No.: 14/123,977

(22) PCT Filed: May 28, 2012
(86) PCT No.: PCT/JP2012/063584

§ 371 Date: Dec. 5, 2013

(30) Foreign Application Priority Data
Jun. 9, 2011 (JP) 2011-128833
Jan. 22, 2012 (JP) 2012-010559

(51) Int. Cl. B42D 5/04

(52) U.S. Cl. CPC B42D 5/041
USPC 283/2

(57) ABSTRACT

Tear-off perforations 3 are formed vertically and horizontally at a rectangular sheet 1 so as to divide the entire sheet 1 into sixteen equal rectangular leaves 5. The sixteen leaves 5 are provided with binding holes 7 at two corresponding places along one side corresponding to one another. The sixteen leaves 5 have the front surfaces printed in an identical attitude relative to the one corresponding side. Monthly tables of January to December of a prescribed year and monthly tables of January to March of the following year are printed on fifteen leaves out of the sixteen leaves 5. Thus, the manufacturing costs of the printed plurality of leaves can be reduced.

### TECHNICAL FIELD

The present invention relates to a printed leaf suitable for use with a desktop leaf base, a bound leaf, a leaf providing method, a folding printed leaf being the folded printed leaf, and a book in which the printed leaf is bound into at least part of the book.

### BACKGROUND ART

Conventionally, what are known are: a desktop leaf base (of the applicant of the present invention disclosed in, for example, Patent Literature 1) in which binding holes are formed along one side of a set of (for example, twelve months) leaves with printed calendar monthly tables or the like, and the set of leaves can be used as a desk calendar by being replaceably held by a binder; and a magnet-equipped binder (of the applicant of the present invention disclosed in, for example, Patent Literature 2) that makes it possible for such a set of leaves to be used as a wall calendar. FIG. 10 is a perspective view showing the appearance of a desk calendar of the desktop leaf base disclosed in Patent Literature 1, the desktop leaf base holding leaves with printed monthly tables. As shown in FIG. 10A, monthly tables of different months are printed on a set (for example, twelve pieces) of leaves 75. The monthly tables include month numerals 79. Further, binding holes 77 are formed at two places along the top side of each leaf 75. As shown in FIG. 10B, the desktop leaf base 201 has a base body 70 being substantially trapezoidal as seen from sideways, and ring binders 71 attached to the top face of the base body 70. By opening the rings of the ring binders 71 and allowing the two rings of the ring binders 71 to pass through the binding holes 77 of a set of leaves 75, and thereafter closing the rings, the leaves 75 can be suspended on the ring binders 71. In this manner, a desk calendar with which a set of monthly tables can be replaced each year can be implemented. When the monthly table of the leaf 75 appearing on the front side becomes unnecessary in accordance with a lapse of the month indicated by the month numeral 79, by turning the leaf 75 to the back side of the desktop leaf base 201, the monthly table of the following month can be shown.

FIG. 11 is a perspective view showing the appearance of a wall calendar, in which a set of leaves with printed monthly tables are held by the magnet-equipped binder disclosed in Patent Literature 2. As shown in FIG. 11A, monthly tables of different months are printed on a set (for example, twelve pieces) of leaves 85. Each monthly table includes a month numeral 89. Further, binding holes 87 are formed at two places along the top side of each leaf 85. As shown in FIG. 11B, a magnet-equipped binder 202 has a plate-like base member 80, and ring binders 81 attached to the front surface of the base member 80. The magnet-equipped binder 202 is further equipped with a magnet (not shown) that causes the back surface to attach to a magnetic substance wall such as an iron wall. Thus, the magnet-equipped binder 202 can be removably held onto the magnetic substance wall. Further, a suspension string 82 is provided to the base member 80. Accordingly, the magnet-equipped binder 202 can be suspended on a nail on the wall or the like through use of the suspension string 82. By opening the rings of the ring binders 81 and allowing two rings of the ring binders 81 to pass through the binding holes 87 of a set of leaves 85, and thereafter closing the rings, the leaves 85 can be suspended on the ring binders 81. In this manner, a wall calendar with which a set of monthly tables can be replaced each year can be implemented. When the monthly table of the leaf 89 appearing on the front side becomes unnecessary in accordance with a lapse of the month indicated by the month numeral 89, by removing the leaf 89 from the rings of the ring binders 81, the monthly table of the following month can be shown.

When an advertiser sends every year to each of customers or potential customers just a set of leaves 75, 85 on which monthly tables are printed and binding holes 77, 87 are formed as an advertisement medium, for example, the advertiser can maintain the relationship with the customers or the like at low costs. However, there is a problem that, the cost itself for manufacturing a set of leaves, for example twelve leaves 75, 85 is not different from the cost required for manufacturing leaves of a conventional desk calendar.

### CITATION LIST

### Patent Literature

Patent Literature 1: JP 4628480 B1
Patent Literature 2: JP 4709940 B1

### SUMMARY OF INVENTION

### Technical Problem

The present invention is made in consideration of the problem described above, and an object of the present invention is to provide a printed leaf with which manufacturing costs of a printed plurality of leaves can be reduced. Another object of the present invention is to provide a bound leaf made with the printed leaf. Still another object of the present invention is to provide a leaf providing method for manufacturing leaves from the printed leaf and providing the leaves to a customer, a folding printed leaf being the folded printed leaf, and a book into which the printed leaf is bound into at least part of the book.

### Solution to Problem

In order to solve the foregoing problem and to achieve the foregoing object, a first aspect of the present invention provides a rectangular sheet-like printed leaf including tear-off perforations formed vertically and horizontally so as to divide the entire printed leaf into four or more equal rectangular leaves. Binding holes are formed in a plurality of leaves out of the four or more leaves at a plurality of corresponding sites along one side corresponding to one another among the plurality of leaves. The plurality of leaves are, on one common main surface, printed in an identical attitude among one another relative to the corresponding one side. Further, the plurality of leaves are printed also on other common main surface, and the printing on the one main surface of each of the plurality of leaves and the printing on the other main surface of a corresponding one of the plurality of leaves are identical to each other in an attitude.

With such a configuration, by separating leaves along the perforations, and for example, allowing a plurality of binder rings of a desktop leaf base having a binder to respectively pass through a plurality of binding holes of the leaves, the plurality of leaves out of the separated four or more leaves can be replaceably suspended on the desktop leaf base to be used. Though the printed leaf is four or more times as large as each leaf to be used, despite its size being four or more times as large as the leaf, printing and formation of the perforations and binding holes can be carried at substantially the same costs. Accordingly, costs required for manufacturing a prescribed number of leaves can be reduced. Further, even when the sheet is too large in size, by simply folding the sheet along the perforations instead of separating the sheet along the perforations, it becomes possible to reduce the area such that the printed leaf can be delivered to the user by mail or the like of a low shipping charge. As compared to the work of separating leaves along perforations and overlapping the separated leaves, the simple folding work can be performed more quickly at lower costs, whether it is carried out mechanically or manually. Further, as to the packing work with envelopes or the like for shipping also, it is easier to pack folded leaves than to pack stacked leaves, and hence excellent workability is achieved. In the case where the sheet is not too large in size, without being folded, the sheet can be shipped as it is through use of mail or the like of a low shipping charge.

A second aspect of the present invention provides a bound leaf including leaves separated from the printed leaf according to the first aspect, the leaves separated along the perforations being bound by a binder capable of opening and closing such that the one side is aligned with one another.

A third aspect of the present invention provides a leaf providing method, including a step of manufacturing the printed leaf according to the first aspect, a step of separating each of the leaves from the printed leaf along the perforations, a step of stacking and packing the separated leaves, and a step of shipping the packed leaves to a customer.

A fourth aspect of the present invention provides a folding printed leaf being the printed leaf according to the first aspect being folded, in which the rectangular printed leaf is band-like. The tear-off perforations include two or more perforations that extend in a short side direction of the band-like printed leaf and that are juxtaposed to each other in a long side direction of the band-like printed leaf. The printed leaf is zigzag-folded employing each of the two or more perforations juxtaposed to each other in the long side direction as a fold line.

A fifth aspect of present invention provides a book into which a plurality of leaves are bound, in which at least one leaf out of the plurality of leaves includes the printed leaf according to the first aspect, and the printed leaf is capable of being separated from the remainder of the book along tear-off perforations.

A sixth aspect of the present invention provides the book into which the plurality of leaves are bound, in which at least one leaf out of the plurality of leaves includes other rectangular sheet-like printed leaf capable of being separated along tear-off perforations. The other printed leaf includes tear-off perforations formed in one of a vertical manner, a horizontal manner, and a vertical and horizontal manner, so as to divide the entire other printed leaf into two or more equal rectangular leaves. Binding holes are formed in a plurality of leaves out of the two or more leaves at a plurality of corresponding sites along one side corresponding to one another among the plurality of leaves. The plurality of leaves are, on one common main surface, printed in an identical attitude to one another relative to the corresponding one side. The plurality of leaves are printed also on other common main surface. The printing on the one main surface of each of the plurality of leaves and the printing on the opposite main surface of a corresponding one of the plurality of leaves are identical to each other in attitude.

A seventh aspect of the present invention provides a book into which a plurality of leaves are bound, in which at least one leaf out of the plurality of leaves includes a rectangular sheet-like printed leaf capable of being separated along tear-off perforations. Binding holes are formed in the printed leaf at a plurality of sites along one side. The printed leaf are, on both main surfaces, printed in an identical attitude.

### Advantageous Effect of Invention

As described above, with the printed leaf of the present invention, manufacturing costs of printed plurality of leaves can be reduced. Further, with the bound leaf of the present invention and the leaf providing method of the present invention, since the printed leaf of the present invention is used, the manufacturing costs thereof can be reduced. Further, the folding printed leaf of the present invention makes it possible to reduce the size without the necessity of separating the printed leaf along the tear-off perforations. Still further, the book of the present invention allows the user to separate and use any leaf included in the bound printed leaf.

### BRIEF DESCRIPTION OF THE DRAWINGS

FIG. 1 is a plan view showing the front surface of a printed leaf according to a first embodiment of the present invention.

FIG. 2 is a rear view showing the back surface of the printed leaf shown in FIG. 1.

FIG. 3 is an exterior perspective view exemplarily showing a shipping manner of the printed leaf shown in FIG. 1 by mail.

FIG. 4 is an exterior perspective view exemplarily showing the usage manner of the printed leaf shown in FIG. 1, in which FIG. 4A is a perspective view showing the front side and FIG. 4B is a perspective view showing the rear side.

FIG. 5 is a diagram showing a printed leaf according to a second embodiment of the present invention, in which: FIG. 5A is a plan view showing the front surface; FIG. 5B is a rear view showing the back surface; and FIG. 5C is a rear view showing other example of the back surface.

FIG. 6 is a diagram showing a printed leaf according to a third embodiment of the present invention, in which FIG. 6A is a plan view showing the front surface and FIG. 6B is a rear view showing the back surface.

FIG. 7 is an exterior perspective view exemplarily showing the usage manner of the printed leaf shown in FIG. 6, in which FIG. 7A is a perspective view as seen from the front side and FIG. 7B is a perspective view as seen from the rear side.

FIG. 8 is a diagram showing a printed leaf according to a fourth embodiment of the present invention, in which FIG. 8A is a perspective view showing a set of leaves after being separated, and FIG. 8B is a perspective view exemplarily showing the usage manner of the separated leaves.

FIG. 9 is a plan view showing a printed leaf according to a fifth embodiment of the present invention.

FIG. 10 is a diagram showing a desk calendar according to the background art of the present invention, in which FIG. 10A is a perspective view showing a set of leaves used for the desk calendar and FIG. 10B is a perspective view of the desk calendar.

FIG. 11 is a diagram showing a wall calendar according to the background art of the present invention, in which FIG. 11A is a perspective view showing a set of leaves used for the wall calendar and FIG. 11B is a perspective view of the wall calendar.

FIG. 12 is a perspective view showing the front side of a folding printed leaf according to other embodiment of the present invention.

FIG. 13 is a perspective view showing the back side of the folding printed leaf shown in FIG. 12.

FIG. 14 is a perspective view showing a book according to another embodiment of the present invention, particularly, the book in the open state.

FIG. 15 is a plan view showing a printed leaf according to still another embodiment of the present invention.

FIG. 16 is a plan view showing a printed leaf according to still another embodiment of the present invention.

FIG. 17 is a perspective view showing a book according to still another embodiment of the present invention, particularly the book in the open state.

FIG. 18 is a perspective view showing a book according to still another embodiment of the present invention, particularly the book in the open state.

### DESCRIPTION OF EMBODIMENTS

### First Embodiment

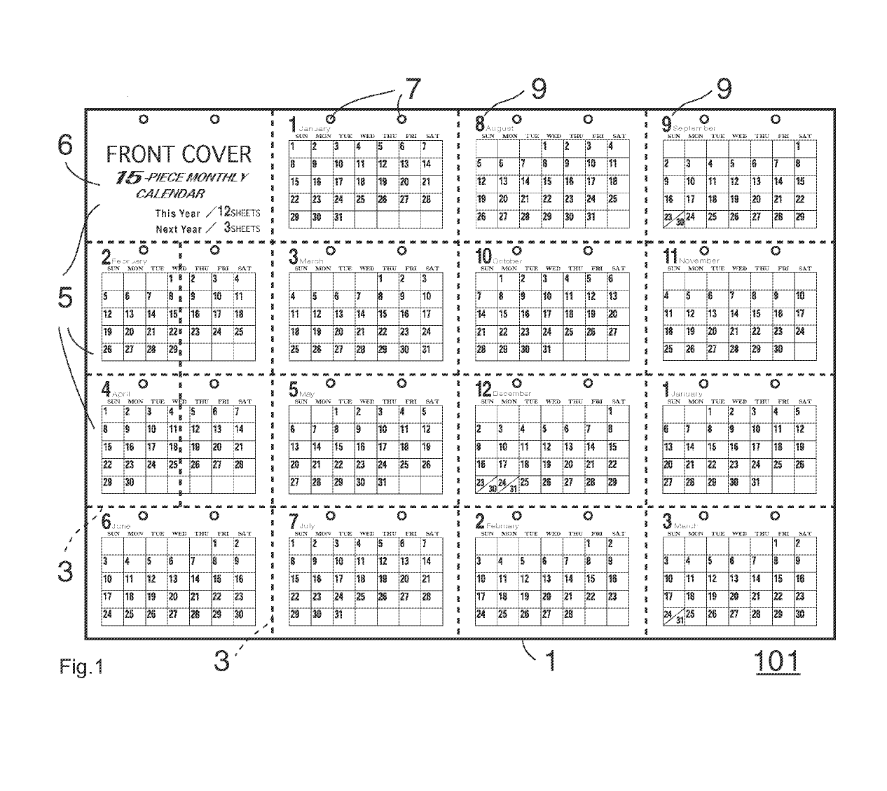

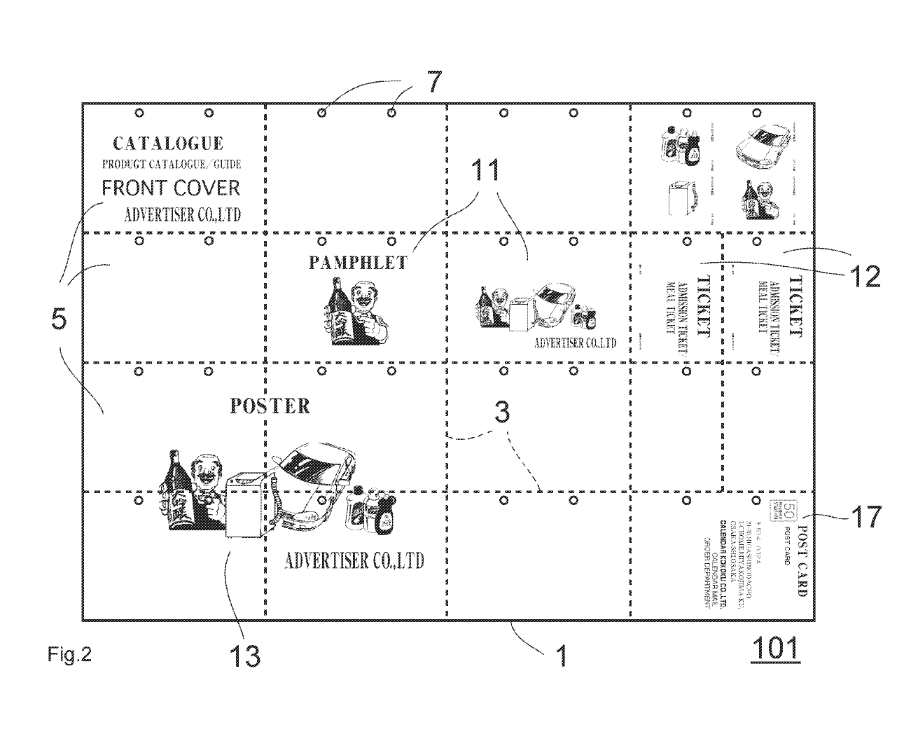

FIG. 1 is a plan view showing the front surface of a printed leaf according to a first embodiment of the present invention. Further, FIG. 2 is a rear view showing the back surface of the printed leaf. The printed leaf 101 is a sheet-like printed matter, being a rectangular sheet 1 having its front and back surfaces printed. The sheet 1 is, for example, printing paper having the rigidity as great as that of a monthly table leaf of conventionally-known desk calendars. The size of the sheet 1 is, as an example, A2 size. The sheet 1 is provided with perforations 3 vertically and horizontally, such that the entire sheet 1 is divided into sixteen equal rectangular leaves 5. The perforations 3 are, as a preferred example, formed as so-called micro perforations, which do not leave noticeable irregularity on the cutout line after the leaves 5 are separated along the perforations 3, and which facilitate separation. As one example, the size of one leaf 5 is A6 size.

The sixteen leaves 5 are each provided with binding holes 7 along the upper side, i.e., the top side in the drawing. The binding holes 7 are formed at two places in a corresponding manner among sixteen leaves 5 relative to the top side. As shown in FIG. 1, a calendar is printed on the front surface of the sheet 1. More specifically, on the front surface of the sheet 1, a front cover 6 is printed on one leaf 5 out of the sixteen leaves 5, and calendar monthly tables bearing different month numerals 9 are respectively printed on the rest of fifteen leaves 5. The fifteen monthly tables are respectively monthly tables of January to December of a prescribed year and January to March of the following year. The front cover 6 and the monthly tables are printed in the attitude in which the top side in the drawing is the top side of the leaves 5.

Thus, the printed leaf 101 is provided with binding holes 7 along one side of the sixteen leaves 5 and at the sites in a corresponding manner among sixteen leaves 5. Further, the front cover 6 or the monthly tables are printed on the front surface of the leaves 5 in the attitude in which the one side is the top side of the leaves 5. In FIG. 1, while the binding holes 7 are formed along the top side in the drawing throughout the sixteen leaves 5, the binding holes 7 are only required to be formed along one side in a corresponding manner among the leaves 5. For example, out of the sixteen leaves 5 of four rows and four columns, the binding holes 7 may be formed along the bottom side in the drawing for the eight leaves 5 of the first and third rows, conversely to the manner in FIG. 1; whereas the binding holes 7 may be formed along the top side in the drawing for the eight leaves 5 of the second and fourth rows identically to the manner in FIG. 1. In this case, the binding holes 7 are aligned on the both sides of the perforations 3 between the first-row leaves 5 and the second-row leaves 5, and on the both sides of the perforations 3 between the third-row leaves 5 and the fourth-row leaves 5. In this case also, the front cover 6 or the monthly tables are printed on the sixteen leaves 5 in the attitude in which the one side along which the binding holes 7 are aligned is the top side.

As shown in FIG. 2, on the back surface of the printed leaf 101, advertisements are printed. The advertisements include an advertisement 13 printed across four leaves 5, an advertisement 11 printed for each of the leaves 5, a postcard 17 on which an order form addressed to the advertiser is printed, and admission tickets 12 offered by the advertiser. Though not shown in the drawing, it is also possible that one advertisement is printed over the entire sixteen leaves 5. Each admission ticket 12 is half as great as the leaf 5. Two admission tickets 12 are respectively printed on two regions, which are obtained by dividing one leaf 5 into two equal pieces by the perforations 3. It goes without saying that, without being limited to the admission tickets 12, it is also possible to print any instrument which evidences some claim given to the receiver of the printed leaf 101 from the advertiser for the purpose of promotion, such as discount coupons, point coupons, gift exchange coupons and the like.

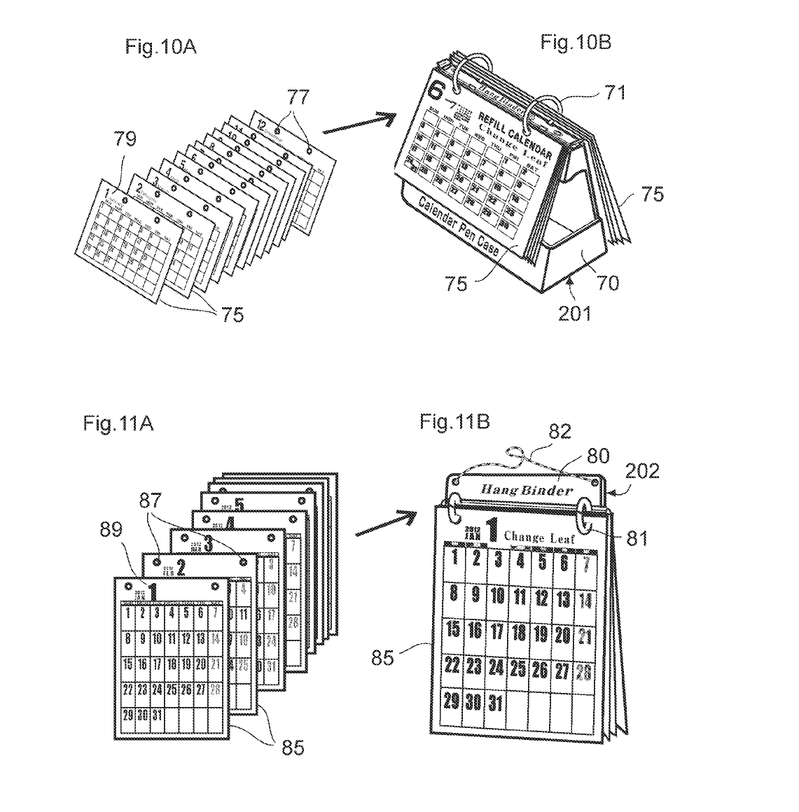

Since the printed leaf 101 is configured as described above, it has the following advantages. By separating the leaves 5 along the perforations 3, and for example allowing the binder rings 71 of the desktop leaf base 201 shown in FIG. 10 to pass through the binding holes of a set of separated leaves 5, the set of leaves 5 can be suspended on the desktop leaf base 201 as being overlapped on one another. Thus, the printed leaf 101 can be used as a desk calendar which includes twelve monthly tables of a prescribed year and the first three months of the following year. It goes without saying that the printed leaf 101 can be used also as a wall calendar, by being applied to the magnet-equipped binder 202 shown in FIG. 11.

Though the printed leaf 101 is sixteen times as large as each leaf 5 for use, printing and formation of the perforations 3 and the binding holes 7 can be carried out substantially at the same costs as a single leaf 5. Accordingly, sixteen leaves 5 can be prepared with reduced costs. It is desirable that the printed leaf 101 firstly undergoes the printing process, and thereafter undergoes the formation process of the perforations 3 and the binding holes 7, because the printing can be carried out on the uniform flat sheet 1, and thus printing is facilitated.

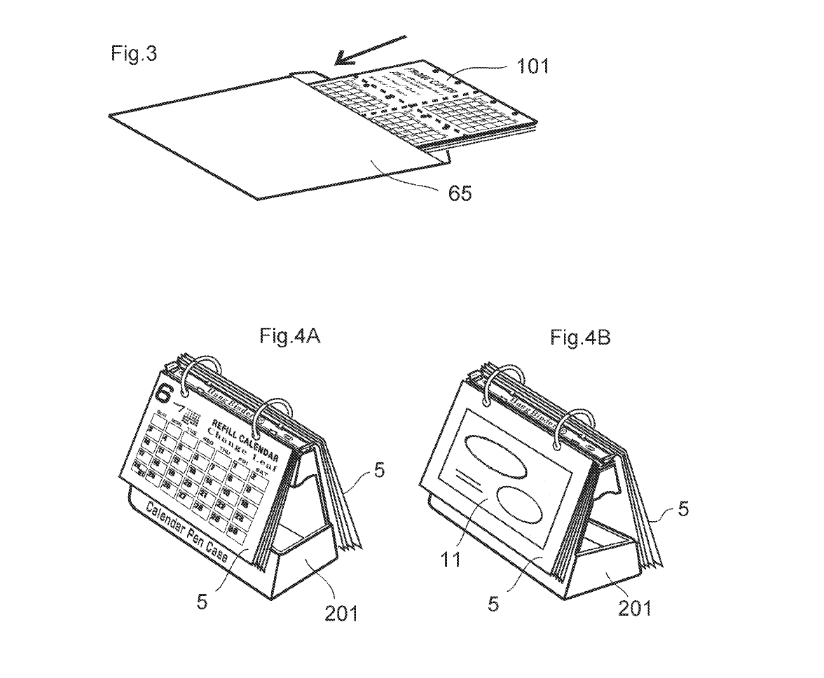

FIG. 3 is an exterior perspective view exemplarily showing a shipping manner of the printed leaf 101 by mail. As exemplarily shown in FIG. 3, without being divided along the perforations 3, the printed leaf 101 can be simply folded along the perforations 3 and inserted into an envelope 65. Thus, a reduction in area is achieved, whereby the printed leaf 101 can be sent to the user by mail of a low shipping charge. For example, by folding the printed leaf 101 twice, the printed leaf 101 can be shaped into A4 size, which is the worldwide standard and most inexpensive size, to be shipped. Even when the perforations 3 are micro perforations, the printed leaf 101 does not break when being folded toward one side only. As compared to the work of separating the leaves 5 along the perforations 3 and overlapping the separated leaves 5, such a simple folding work can be performed faster and at lower costs, mechanically or manually. Further, as to the packing work with envelopes for shipping, it is easier to pack a folded printed leaf 101 than a set of stacked leaves 5. Thus, workability is improved. In this manner, the printed leaf 101 can reduce costs of manufacture, packing, and shipping.

FIG. 4 is an exterior perspective view exemplarily showing the usage manner of the printed leaf 101. FIG. 4A shows the front side, and FIG. 4B shows the rear side. The user of the printed leaf 101 receiving the shipped printed leaf 101 may separate the printed leaf 101 along the perforations 3, such that a set of leaves 5 can be used with the desktop leaf base 201 (see FIG. 10) or the like, as exemplarily shown in FIG. 4. When the perforations 3 are micro perforations, the user can easily separate the printed leaf 101 into a set of leaves 5 by folding the printed leaf 101 toward the side opposite to the folded side along the perforations 3.

Since the printed leaf 101 has the advertisement 13 spanning over two or more leaves 5 printed on its back surface, the user receiving the shipped printed leaf 101 in which the leaves 5 are not separated along the perforations 3 can look the integral advertisement 13 printed on the back surface, before separating and using the leaves 5. Thus, the advertiser who sends the printed leaf 101 as an advertisement medium can strongly impress the user by the great advertisement. Further, by printing an order form in the format of the postcard 17 on the printed leaf 101, the advertiser can stimulate the user to place an order, whereby the advertising effectiveness can be enhanced. Even when the binding holes 7 are formed on the postcard 17, the postcard 17 can be used as a postcard not only in Japan but all over the world without any trouble. In the case where the advertisement 11 (FIG. 2) per leaf 5 is printed on the printed leaf 101, such an advertisement 11 can be displayed on the rear side of the desktop leaf base 201 as exemplarily shown in FIG. 4B.

### Second Embodiment

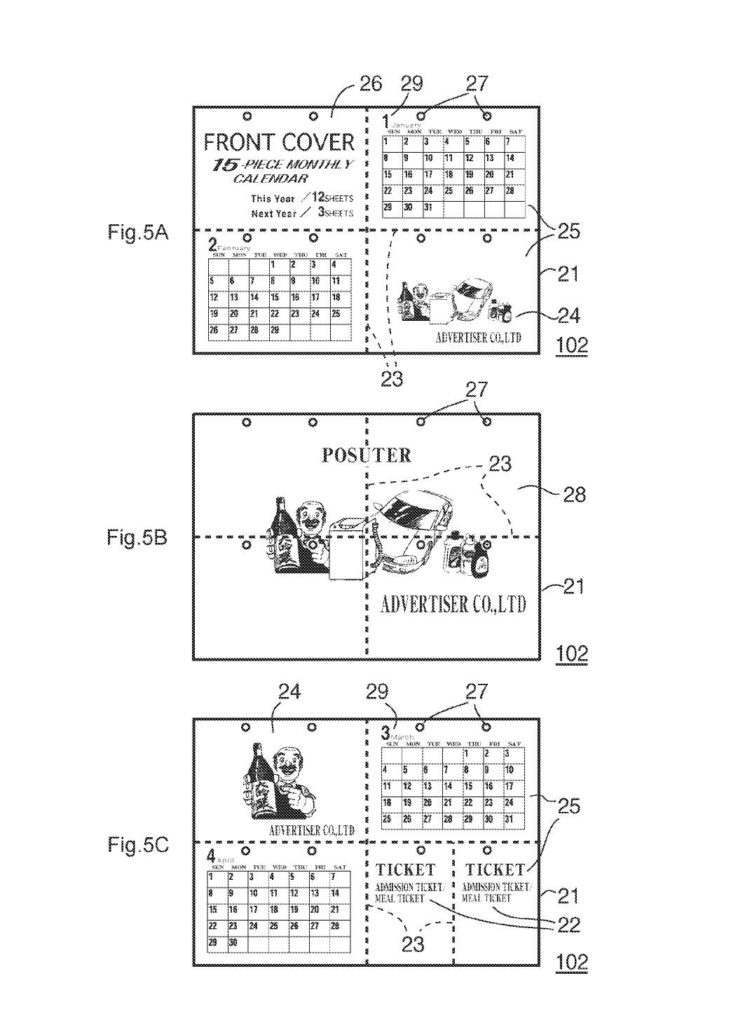

FIG. 5 is a diagram showing a printed leaf according to a second embodiment of the present invention. FIG. 5A is a plan view showing the front surface; FIG. 5B is a rear view showing the back surface; and FIG. 5C is a rear view showing other example of the back surface. The printed leaf 102 is a sheet-like printed matter being a rectangular sheet 21 having its front and back surfaces printed. The size of the sheet 21 is, as an example, A4 size. The sheet 21 is provided with perforations 23 vertically and horizontally, such that the entire sheet 21 is divided into four equal rectangular leaves 25. Similarly to the perforations 3 according to the first embodiment, the perforations 23 are formed as micro perforations, as a preferred example.

The four leaves 25 are each provided with binding holes 27 along the top side in the drawing, in a corresponding manner among the four leaves 25. As exemplarily shown in FIG. 5A, a calendar and an advertisement are printed on the front surface of the sheet 21. More specifically, on the front surface of the sheet 21, a front cover 26 is printed on a leaf 26 out of the four leaves 25; calendar monthly tables bearing different month numerals 29 are respectively printed on two out of the other three leaves 25; and an advertisement 24 is printed on the last one. The front cover, the monthly tables, and the advertisement are printed in the attitude in which the side where the binding holes 27 are formed is the top side of each leaf 25.

As exemplarily shown in FIG. 5B, on the back side of the printed leaf 102, for example, an advertisement 28 may be printed across the entire four leaves 25. As exemplarily shown in FIG. 5C, in addition to the calendar monthly tables and the advertisement 24, admission tickets 22 offered by the advertiser may be printed. Each admission ticket 22 is half as great as the leaf 25. Two admission tickets 22 are respectively printed on two regions, which are obtained by equally dividing one leaf 25 into two pieces by the perforations 23. It goes without saying that, without being limited to the admission tickets 22, it is also possible to print any general credit certificate, as has been described in the first embodiment.

### Third Embodiment

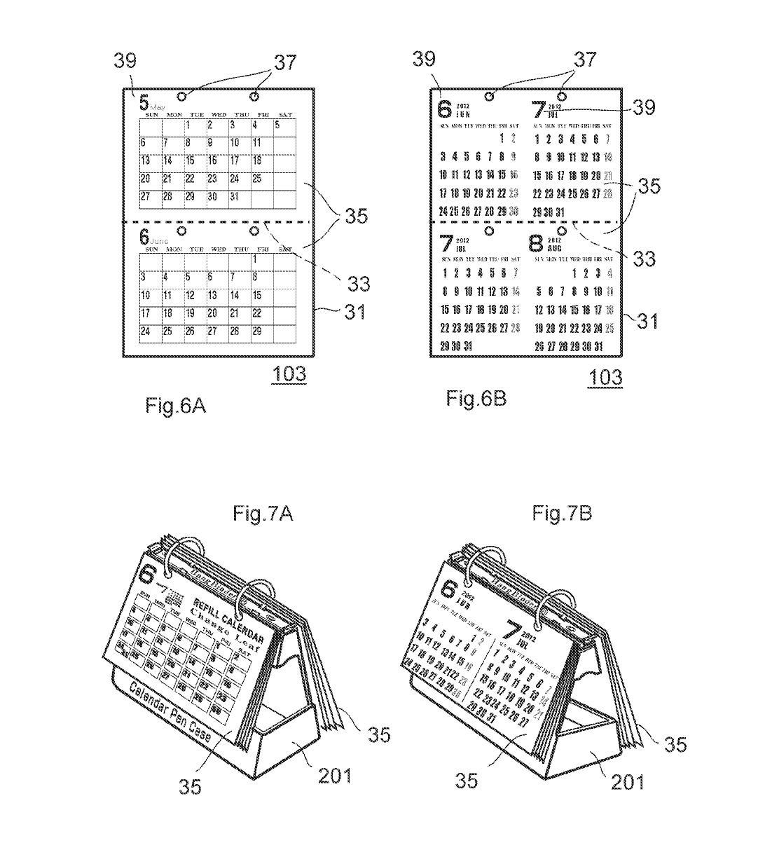

FIG. 6 is a diagram showing a printed leaf according to a third embodiment of the present invention. FIG. 6A is a plan view showing the front surface and FIG. 6B is a rear view showing the back surface. This printed leaf 103 is a sheet-like printed matter being a rectangular sheet 31 having its front and back surfaces printed. The size of the sheet 31 is, as an example, A5 size. The sheet 31 is provided with perforations 33 along the centerline, such that the entire sheet 31 is divided into two equal rectangular leaves 35. Similarly to the perforations 3 according to the first embodiment, the perforations 33 are formed as micro perforations.

On the front surface of the printed leaf 103, calendar monthly tables differing in month numerals 39 are respectively printed on each of the two leaves 35 in the identical attitude. The leaves 35 are each provided with binding holes 37 along the top side at two sites in a corresponding manner between the two leaves 35. On the back surface of the printed leaf 103, calendar monthly tables differing from each other in month numerals 39 are printed on each of the two leaves 35 in an identical attitude, such that the side where the binding holes 37 are formed is the top side.

The printed leaf 103 is prepared, for example, as a set of printed leaves such that, for example, monthly tables for twelve months are set. Here, attention should be given to the fact that the leaf 35, which has the May monthly table printed on its front surface, has the following June monthly table printed on its back surface. Similarly, the leaf 35, which has the June monthly table printed on its front surface, has the following July monthly table printed on its back surface.

FIG. 7 is an exterior perspective view exemplarily showing the usage manner of the printed leaf 103. FIG. 7A is a perspective view as seen from the front side, and FIG. 7B is a perspective view as seen from the rear side. By having each leaf 35 printed as exemplarily shown in FIG. 6, when a set of leaves 35 obtained by being separated from a set of printed leaves 103 hang on the desktop leaf base 201 or the like to be used as a desk calendar, as exemplarily shown in FIG. 7, the monthly table of one identical month can be seen at both the front and back sides of the desk calendar. For example, when a salesperson and a customer discuss business with each other across a desk on which the desktop leaf base 201 is placed, both the salesperson and the customer can refer to the monthly table of an identical month. In addition, since each leaf 35 has the monthly tables for two months printed on its back surface, for example, the customer can refer to not only the relevant month (for example, June) but also the monthly table of the following month (for example, July).

### Fourth Embodiment

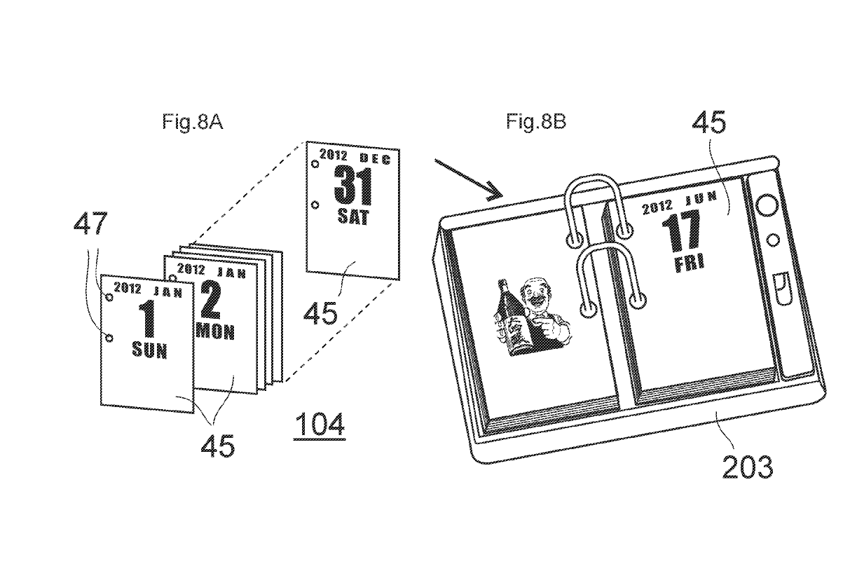

FIG. 8 is a diagram showing a printed leaf according to a fourth embodiment of the present invention. FIG. 8A is a perspective view showing a printed leaf after being separated, and FIG. 8B is a perspective view exemplarily showing the usage manner thereof. Similarly to the printed leaf 101, the printed leaf 104 has, in place of monthly tables, calendar daily tables differing in date numerals printed on the front surface of the leaves 45 each being a rectangular sheet equally divided by perforations. On each leaf 45, year, month, date, and days of the weeks are printed. Further, along the left side as seen from the front surface of each leaf 45, two binding holes 47 are formed. The printed leaf 104 includes, for example, 365 leaves 45 for one year, or 456 leaves 45 for one year and three months. For example, by forming perforations on a sheet in the standard size of series A so as to be divided in to 512 equal pieces, leaves 45 of practical size on which daily tables are printed can be obtained. On the redundant leaves 45 on which the daily tables are not printed, for example, advertisements (not shown) are printed. As shown in FIG. 8A, by separating the printed leaf 104 into a set of leaves 45 and stacking them to be applied to the conventionally known desktop leaf base 203 as shown in FIG. 8B, a page-a-day desk calendar can be provided.

### Fifth Embodiment

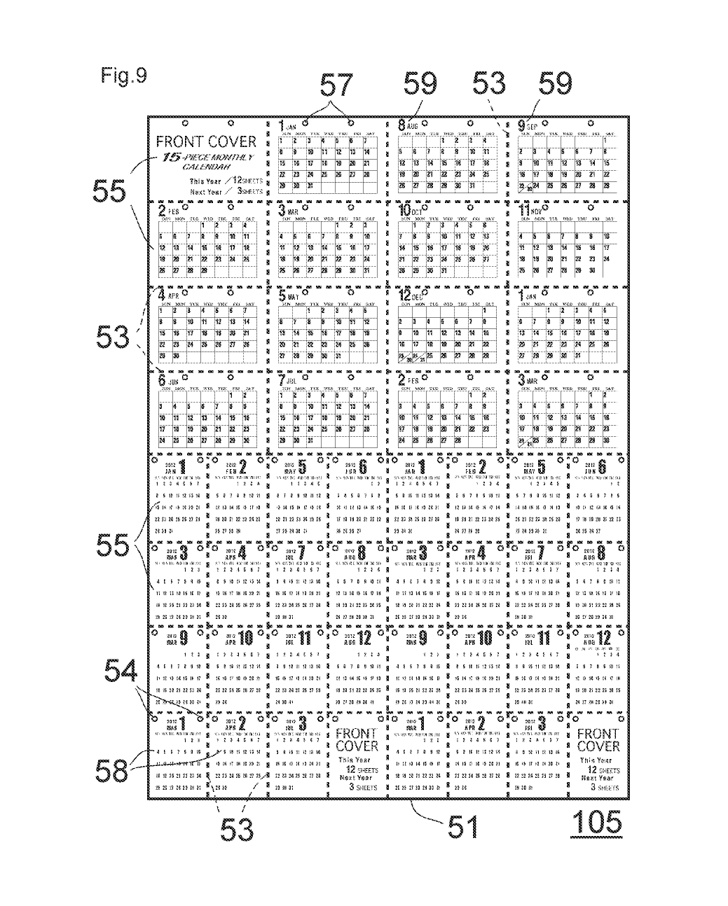

FIG. 9 is a plan view showing a printed leaf according to a fifth embodiment of the present invention. Similarly to the printed leaf 101, the printed leaf 105 has calendar monthly tables differing in month numerals 59 respectively printed on the front surface of leaves 55 being a rectangular sheet 51 equally divided by perforations 53. In the printed leaf 105, a set of monthly tables is printed to each of the top and bottom regions, the top set and the bottom set being of different types. A set of monthly tables printed on the top region is to be applied to the desktop leaf base 201 (FIG. 10), and a set of monthly tables printed on the bottom region is to be applied to the magnet-equipped binder 202 (FIG. 11). Each of the monthly tables of the bottom region is half as great as each of the monthly tables of the top region. Accordingly, in the bottom region, each leaf 55 is divided into two equal small leaves 58 by the perforations 33. Accordingly, the binding holes 57 formed for each leaf 55 in the top region and binding holes 54 formed for each small leaf 58 in the bottom region are different from each other in the position and number, per leaf 5. Per leaf 55, the binding holes 57 are two in number and the binding holes 54 are four in number. However, both the pitch of a pair of rings of the ring binders 71 of the desktop leaf base 201 and the pitch of a pair of rings of the ring binders 81 of the magnet-equipped binder 202 are of the standardized size. Accordingly, for each small leaf 58, the binding holes 54 are two in number and the pitch is identical to that of a pair of binding holes 57. With the printed leaf 105, since two sets of monthly tables can be obtained from a single sheet 51, a further reduction in manufacturing costs can be achieved. Such a printed leaf 105 is particularly suitable for shipping two sets of monthly tables, i.e., for use with the desktop leaf base 201 and for use with the magnet-equipped binder 202, to an identical customer.

### Other Embodiment

(1) A printed leaf including four or more leaves, such as the printed leaf 101, 102, 105 according to the first, second, and fifth embodiments, respectively, may partially include a leaf with no binding holes. That is, it is also possible to implement a printed leaf including a plurality of leaves with the binding holes and the rest of the leaves with no binding holes. Alternatively, the rest of the leaves may be provided with binding holes differing in pitch or number of pieces from the binding holes of the plurality of leaves. Alternatively, the rest of the leaves may be further equally divided by perforations, and binding holes may be provided to each of the divided small leaves. The fifth embodiment is an example of such a mode.

(2) With the printed leaves 101 to 105 according to the first to fifth embodiments, the binding holes 7, 27, 37, 47, 57, 54 are formed at each leaf 5, 25, 35, 45, 55, 58. On the other hand, it is also possible to prepare a printed leaf with no binding holes. A set of leaves, with no binding holes, being printed in a common attitude relative to one corresponding side is suitable for, for example, manufacturing trump cards.

(3) As has been described in the first embodiment, in manufacturing the printed leaf 101 to 105, it is preferable to carry out printing, and thereafter form the perforations 3, 23, 33, 53 and the binding holes 7, 27, 37, 57, 54, because printing can be carried out on the uniform flat sheet 1, 21, 31, 51, and thus printing is facilitated. The manufacturing method may include the steps of preparing a sheet slightly greater than the sheet 1, 21, 31, 51; printing on the sheet; thereafter forming the perforations 3, 23, 33, 53 and the binding holes 7, 27, 37, 57, 54; and cutting the slightly greater sheet into the size of the sheet 1, 21, 31, 51 at any step after printing. Carrying out printing on a sheet that includes the sheet 1, 21, 31, 51 and that is slightly greater than the sheet 1, 21, 31, 51 corresponds to carrying out printing on the sheet 1, 21, 31, 51. Accordingly, the method including the step of preparing a slightly greater sheet is just the same in that it includes carrying out printing on the sheet 1, 21, 31, 51, and thereafter forming the perforations 3, 23, 33, 53 and the binding holes 7, 27, 37, 57, 54.

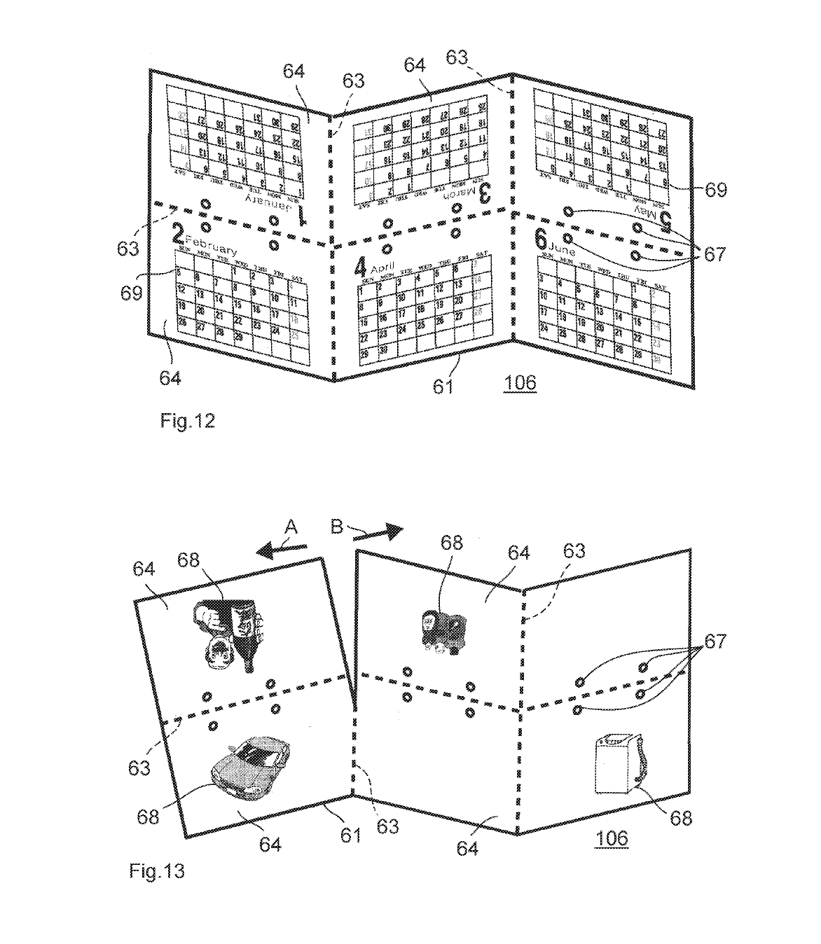

(4) FIG. 12 is a perspective view showing the front side of a folding printed leaf according to other embodiment of the present invention. Further, FIG. 13 is a perspective view showing the back side of the folding printed leaf shown in FIG. 12. A folding printed leaf 106 is a sheet-like printed matter, being a rectangular and band-like sheet 61 having its front surface and back surface printed. The sheet 61 is provided with perforations 63 vertically and horizontally, such that the entire sheet 61 is divided into six equal rectangular leaves 64. The perforations 63 include one line extending in the long side direction of the sheet 61 and two lines extending in the short side direction while being juxtaposed to each other in the long side direction. The perforations 63 are formed as micro perforations, similarly to the perforations 3 according to the first embodiment.

The six leaves 64 are each provided with binding holes 67 along the perforations 63 extending in the long side direction, which is the side common to each other. As exemplarily shown in FIG. 12, calendar monthly tables 69 are printed on the front surface of the sheet 61. Further, as exemplarily shown in FIG. 13, on the back surface of the sheet 61, an advertisement 68 is printed on each of the leaves 64, with a few exceptions. The monthly tables 69 and the advertisements 68 are each printed in the attitude in which the side where the binding holes 67 are formed is the top side of each of the leaves 64.

The folding printed leaf 106 is zigzag-folded, employing the two lines of perforations 63 extending in the short side direction and juxtaposed to each other in the long side direction, as the fold lines. FIGS. 12 and 13 exemplarily show the intermediate state between from the expanded state to the folded state. By folding in a zigzag manner, it becomes possible to fold the folding printed leaf 106 while avoiding separation along the perforations 63 as indicated by arrows A and B in FIG. 13. That is, the folding printed leaf 106 is capable of taking a compact shape being convenient for storage and shipping, while avoiding any damage. For example, after the folding printed leaf 106 is manufactured, by folding the folding printed leaf 106 in a zigzag manner and packing a plurality of folded folding printed leaves 106 as being stacked, and shipping the packed product to the customer, it becomes possible to provide the customer with the leaves 64. In other example, the folding printed leaf 106 may have three or more lines of perforations 63 extending in the short side direction and juxtaposed to one another in the long side direction, and may be zigzag-folded employing the three or more lines of perforations 63 as the fold lines. Note that, in the example shown in FIGS. 12 and 13, the leaf 64 has a standard size of series A or B. Accordingly, the ratio between the long side direction length of the band-like sheet 61 and the short side direction length thereof is approximately 2.1. In view of suitability for zigzag folding, it is desirable that the ratio between the long side direction length of the band-like sheet 61 and the short side direction length thereof is 2 or more.

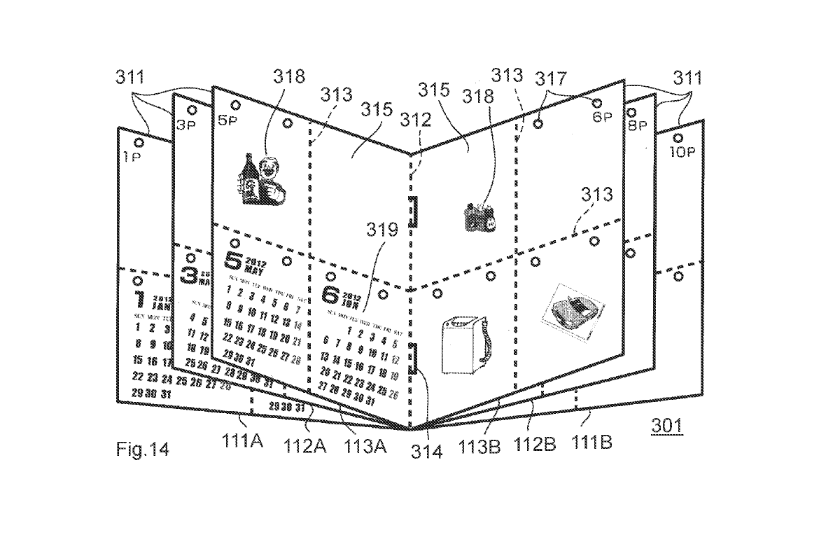

(5) FIG. 14 is a perspective view showing a book according to still another embodiment of the present invention, particularly, the book in the open state. Note that, in the present specification, a “book” includes anything made up of a plurality of leaves (sheets) being bound. For example, a book includes a brochure and a booklet. A book 301 exemplarily shown in FIG. 14 is formed as a brochure. Into the book 301, six leaves (sheets) of rectangular printed leaves 111A to 113A and 111B to 113B are bound. The printed leaf 111A and the printed leaf 111B are coupled to each other, and tear-off perforations 312 are formed between them. The same holds true for the relationship between the printed leaf 112A and the printed leaf 112B, and the relationship between the printed leaf 113A and the printed leaf 113B. For the sake of convenience, the coupled printed leaf 111A and the printed leaf 111B are expressed as a printed leaf 111. The same holds true for the others. Each of the printed leaf 111, 112 and 113 is one example of the printed leaf of the present invention. Three printed leaves 111 to 113 are overlapped with one another, and bound by staples 314 along the perforations 312. That is, the printed leaves 111A to 113A and 111B to 113B are bound in a manner with which any one of them can be torn off along the perforations 312 from the remainder of the book 301.

Each of the printed leaves 111A to 113A and 111B to 113B is a sheet-like printed matter, being a rectangular sheet 311 having its front and back surfaces printed. The sheet 311 is provided with perforations 313 vertically and horizontally, such that the entire sheet 311 is divided into four equal rectangular leaves 315. Similarly to the perforations 3 according to the first embodiment, as one example, the perforations 312 and 313 are formed as micro perforations. Three leaves out of the four leaves 315 are provided with binding holes 317 along the top sides in the drawing, which are sides corresponding to one another. As exemplarily shown in FIG. 14, calendar monthly tables 319 and advertisements 318 are printed on each of the sheet 311. In the example shown in FIG. 14, the calendar monthly tables 319 and the advertisement 318 are printed on part of the four leaves 315, in an attitude in which the side where the binding holes 317 are formed is the top side of each leaf 315. On one main surface common to two leaves 315, the calendar monthly tables 319 are printed, and the advertisement 318 is printed on other common main surface. The monthly tables 319 and the advertisement 318 are printed in an identical attitude on the two main surfaces.

The user provided with the book 301 can separate a desired leaf 315 from the remainder of the book 301 along the perforations 312 and 313. It is also possible to separate any one of the printed leaves 111A to 113A and 111B to 113B in its entirety. Thus, it becomes possible for the user themselves to select the desired leaves 315 with the binding holes 317 and to bind in the file binder for use. That is, it becomes possible for the user to select desired ones out of various contents provided by the book 301 and to create a compilation.

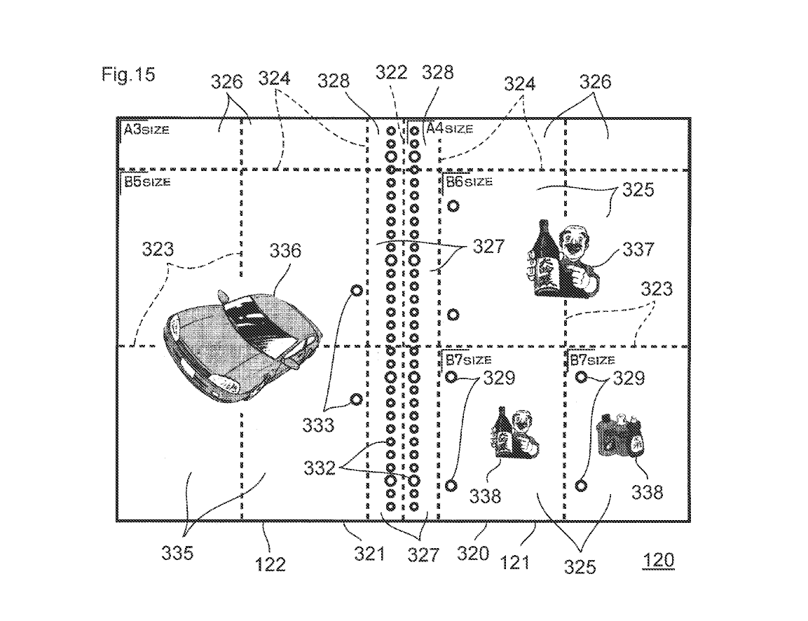

(6) FIG. 15 is a plan view showing a printed leaf according to still another embodiment of the present invention. The printed leaf 120 includes two rectangular coupled sheets 320 and 321 provided with tear-off perforations 322, 323, 324 vertically and horizontally, whereby the printed leaf 120 is divided into four regions 325, four regions 335, four regions 327, two regions 328, and four regions 326. The four regions 325 form a printed leaf 121. Further, the four regions 335 form a printed leaf 122. As an example, the tear-off perforations 322 are formed between the rectangular sheets 320 and 321. The regions 327 and 328 aligned at both sides of the perforations 322 are provided with a plurality of (a multitude of, in FIG. 15) binding holes 332 which make it possible for the leaves to be bound by the binder. By allowing the binding holes 332 to engage with the binder, the printed leaf 120 can be bound with other similar printed leaves, whereby a book can be formed. That is, the printed leaf 120 is suitable for bookbinding by use of a binder.

With the printed leaf 120, the two printed leaves 121 and 122 can be separated from the remainder regions 326, 327, 328 along the perforations 324. Thus, from the book into which the printed leaf 120 is bound, the two printed leaves 121 and 122 on which contents are printed can be separated from the remainder of the book. Further, it becomes also possible to separate each region 325 or a combination of several regions 325 from the remainder of the book. With the printed leaf 120, since the contents-printed printed leaves 121 and 122 are bound into the book through other regions 327 and 328 coupled via the perforations 324, the printed leaves 121 and 122 can be easily separated from the remainder of the book.

In the example shown in FIG. 15, the printed leaf 120 has the size of A3 standard; the two rectangular sheets 320 and 321 each have the size of A4 standard; and the two printed leaves 121 and 122 each have the size of B5 standard. The regions 325 and 335 each have the size of B7 standard. The printed leaf 121 is provided with two binding holes 329 in each of one B6 standard leaf and two B7 standard leaves along each one side of them. An advertisement 338 is printed on the front surface of each of the two B7 standard leaves in an identical attitude in each of the leaves relative to the one side where the binding holes 329 are formed. For example, on the back surface of the two B7 standard leaves, not-shown calendar monthly tables are printed in an identical attitude as the advertisements 338 of the front surface. The one B6 standard leaf also has an advertisement 337 printed on its front surface. On the printed leaf 122, one B5 standard leaf made up of four regions 335 is formed. Along one side of the one leaf, two binding holes 333 are formed. On the front surface of the leaf, an advertisement 336 is printed across the four regions 335. For example, on the back surface of this leaf, not-shown calendar monthly tables are printed in an identical attitude as the advertisement 335 on the front surface. The user can separate a desired leaf with binding holes 329, 333 from the printed leaf 120 bound into a book, and can use it as being bound by a file binder. Note that, the perforations 322 may not be formed.

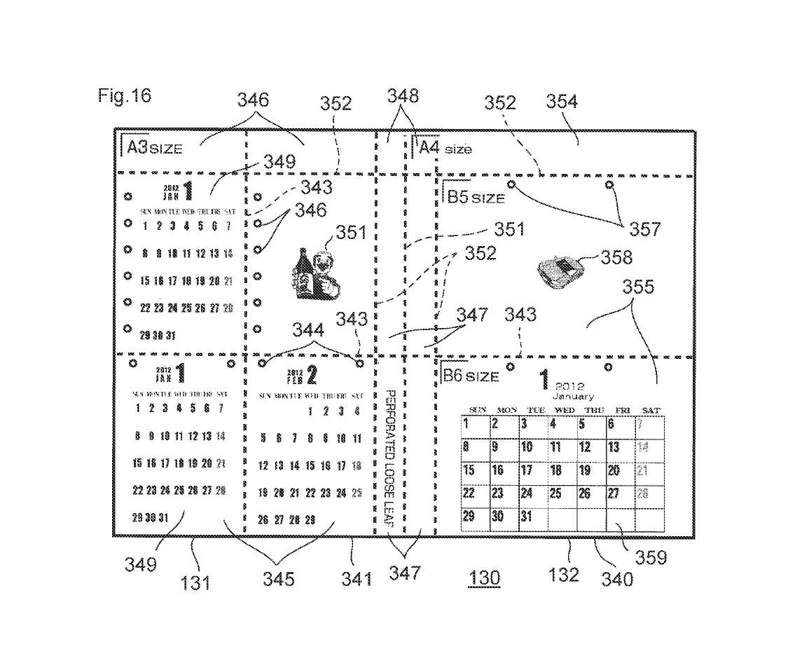

(7) FIG. 16 is a plan view showing a printed leaf according to still another embodiment of the present invention. Similarly to the printed leaf 120 (FIG. 15), the printed leaf 130 includes two rectangular coupled sheets 340 and 341 provided with tear-off perforations 343, 351, 352 vertically and horizontally, whereby the printed leaf 130 is divided into four regions 345, two regions 355, four regions 347, two regions 348, two regions 346, and one region 354. The four regions 345 form a printed leaf 131. Further, the two regions 355 form a printed leaf 132. As an example, tear-off perforations 351 are formed between the rectangular sheets 340 and 341. Being different from the printed leaf 120 (FIG. 15), a plurality of binding holes 332 (FIG. 15) which enable binding by a binder are not formed at the regions 347 and 348 aligned on both sides of the perforations 351. The printed leaf 120 can be bound with other similar printed leaf by a thread or the like along the perforations 351, whereby a book can be formed.

With the printed leaf 130, the two printed leaves 131 and 132 can be separated from the remainder regions 346, 347, 348, 354 along the perforations 352. Thus, from the book into which the printed leaf 130 is bound, the two printed leaves 131 and 132 on which contents are printed can be separated from the remainder of the book. Further, it becomes also possible to separate each of the regions 345, 355 from the remainder of the book. With the printed leaf 130, since the contents-printed leaves 131 and 132 are bound into the book through other regions 347 and 348 coupled via the perforations 352, the printed leaves 131 and 132 can be easily separated from the remainder of the book.

In the example shown in FIG. 16, the printed leaf 130 has the size of A3 standard; the two rectangular sheets 340 and 341 each have the size of A4 standard; and the two printed leaves 131 and 132 each have the size of B5 standard. The regions 355 each have the size of B6 standard; and the regions 345 each have the size of B7 standard. The printed leaf 131 is provided with two binding holes 344 along the top side in the drawing or six binding holes 346 along the left side in the drawing, at each of the four B7 standard leaves. Among the leaves having the binding holes 344 or the binding holes 346 in a common manner, contents such as the calendar monthly tables 349 or the advertisement 351 are printed in an identical attitude relative to one side where these binding holes 344 or 346 are formed. On the back surface of these leaves also, some contents which are not shown are printed in an identical attitude as the contents on the front surface. On the printed leaf 132, in each of the two B6 standard leaves, two binding holes 357 are formed along the top side in the drawing. To the two leaves, contents such as a calendar monthly table 359 or an advertisement 358 are printed in an identical attitude relative to one side where the binding holes 357 are formed. On the back surface of the leaves also, some not-shown contents are printed in an identical attitude as the contents on the front surface. The user may separate a desired leaf with the binding holes 344, 346, 357 from the printed leaf 130 bound into a book, and can use it as being bound by a file binder. Note that, the printed leaf 130 can be bound into a book along the boundary between the two rectangular sheets 340 and 341 without the perforations 351 being formed. Alternatively, the perforations 351 may be replaced by saddle-stitch bookbinding purpose perforations.

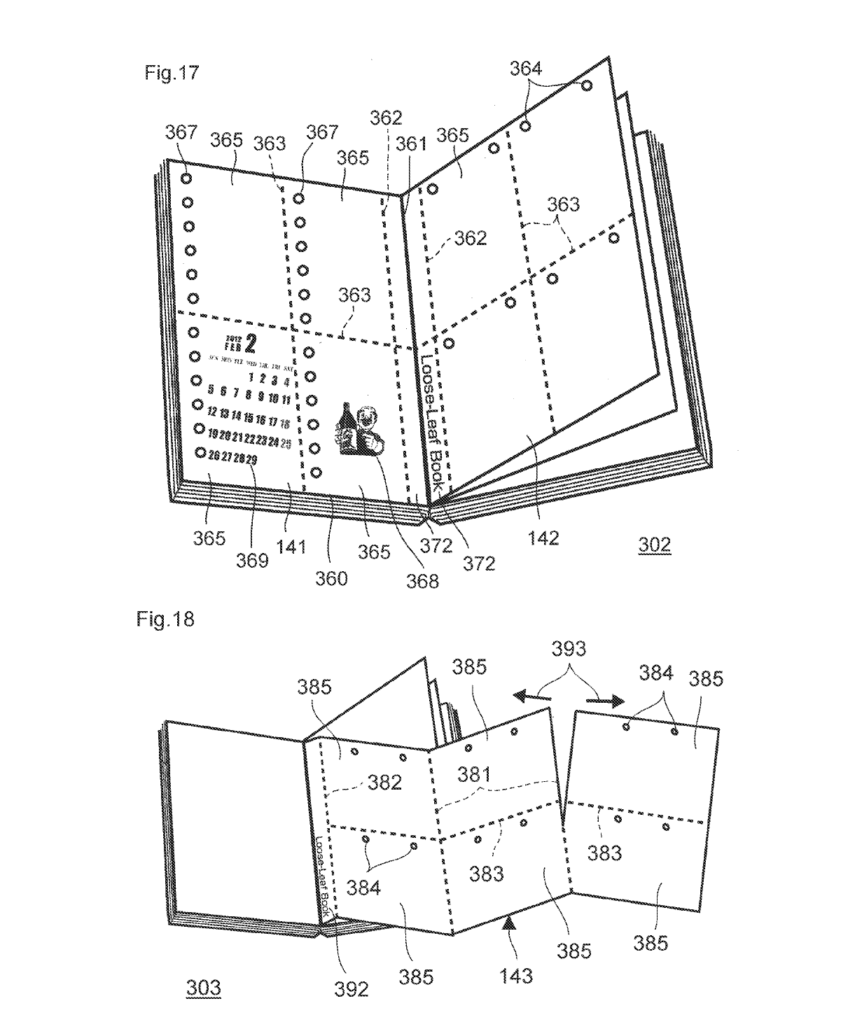

(8) FIG. 17 is a perspective view showing a book according to still another embodiment of the present invention. Particularly, the book is shown as being open. Into the book 302, a multiple of printed leaves each being similar to the printed leaf 130 (FIG. 16) are bound. In FIG. 17, on the left side of the open page, a printed leaf 141 is bound into the book 302 via a region 372. The region 372 functioning as the binding margin is coupled to the printed leaf 141 via tear-off perforations 362. In FIG. 17, on the right side of the open page, a printed leaf 142 is bound into the book 302 via the region 372. The region 372 is coupled to the printed leaf 142 via the tear-off perforations 362.

The printed leaf 141 is divided into four leaves 365 by tear-off perforations 363 formed vertically and horizontally. To each of the four leaves 365, six binding holes 367 are formed along the left side in the drawing. To two leaves out of the four leaves 365, contents such as a calendar monthly table 369 or an advertisement 368 are printed in an identical attitude relative to one side where the binding holes 367 are formed. On the back surface of the leaves 365 also, some not-shown contents are printed in an identical attitude as the contents on the front surface. Similarly, the printed leaf 142 is also divided into four leaves 365 by tear-off perforations 363 formed vertically and horizontally. To each of the four leaves 365, two binding holes 364 along the top side in the drawing are formed. The front surface of the four leaves 365 is not printed. Though not shown, on the back surface of these leaves 365, contents are printed in an identical attitude to each other relative to one side where the binding holes 364 are formed. The user can separate a desired leaf 365 out of the printed leaves 141 and 142 bound into the book 302 from the remainder of the book 302, and use the leaf as being bound by a file binder.

(9) It is also possible to implement a book into which a plurality of leaves are bound, in which only one leaf (sheet) includes any one of printed leaves 111A to 113A, 111B to 113B, 121, 122, 131, 132, 141 and 142 shown in FIGS. 14 to 17, while the other leaves (sheets) include just ordinary printed matters with no tear-off perforations or binding holes. Such a book also is included in the scope of the present invention. Further, while examples in which calendars and advertisements are printed on various printed leaves have been shown in FIGS. 12 to 17, it goes without saying that contents other than calendars or advertisements can be printed as well.

(10) FIG. 18 is a perspective view showing a book according to still another embodiment of the present invention. Particularly, the book is shown as being open. Into the book 303, a printed leaf 143 is bound. A region 392 functioning as a binding margin is coupled to the printed leaf 143 via tear-off perforations 382. The printed leaf 143 is divided into six leaves 385 by vertically formed tear-off perforations 381 and horizontally formed tear-off perforations 383. The printed leaf 143 can be stored in the book 303 by being folded in a zigzag manner along the vertical perforations 381, without being sticking out from other leaves.

To each of the six leaves 385, two binding holes 384 are formed along the top side in the drawing. Though not shown, some contents are printed on at least two leaves out of the six leaves 385 in an identical attitude relative to one side where the binding holes 384 are formed. On the back surface of the at least two leaves 385 also, some not-shown contents are printed in an identical attitude as the contents on the front surface. The user can tear off a desired leaf 385 out of the printed leaf 143 bound into the book 303 from the remainder of the book 303 along perforations 381, 382, or 383 as indicated by arrows 393, and use the leaf as being bound by a file binder.

The present application is based on Japanese Patent Application Nos. 2011-128833 and 2012-10559 filed by the applicant of the present application on Jun. 9, 2011 and Jan. 22, 2012, respectively, the contents of which are incorporated herein by reference in its entirety.

The foregoing description as to specific embodiments of the present invention is of an exemplary nature. They are not exhaustive, and are not intended to limit the present invention to the exact described embodiments. It is apparent to those skilled in the art that numerous modifications and changes can be made based on the foregoing description.

### REFERENCE SIGNS LIST

1, 21, 31, 51, 61, 311, 320, 321, 340, 341 SHEET
3, 23, 33, 53, 63, 313, 312, 322, 323, 324, 343, 351, 352, 362, 363, 381, 382, 383 PERFORATION
5, 25, 35, 45, 55, 58, 64, 315, 365, 385 LEAF
7, 27, 37, 57, 67, 317, 329, 333, 344, 346, 357, 364, 367, 384 BINDING HOLE
13, 28, 68, 318, 336, 337, 338, 351, 358, 368 ADVERTISEMENT
69, 319, 349, 359, 369 CALENDAR (MONTHLY TABLE)
101 to 105, 106, 111A to 113A, 111B to 113B, 121, 122, 141, 142, 143 PRINTED LEAF
301, 302, 303 BOOK

1. A rectangular sheet-like printed leaf, comprising:
tear-off perforations formed vertically and horizontally so as to divide the entire printed leaf into four or more equal rectangular leaves; and
binding holes formed in a plurality of leaves out of the four or more leaves at a plurality of corresponding sites along one side corresponding to one another among the plurality of leaves, wherein
the plurality of leaves are, on one common main surface, printed in an identical attitude among one another relative to the corresponding one side, and
the plurality of leaves are printed also on other common main surface, wherein
the printing on the one main surface of each of the plurality of leaves and the printing on the other main surface of a corresponding one of the plurality of leaves are identical to each other in an attitude.

2. The printed leaf according to claim 1, wherein
the printing on the one common main surface is a printed calendar, and
the printing on the other common main surface is a printed advertisement.

3. A bound leaf, comprising:
leaves separated from a printed leaf, the printed leaf being rectangular and sheet-like, the printed leaf comprising:
tear-off perforations formed vertically and horizontally so as to divide the entire printed leaf into four or more equal rectangular leaves; and
binding holes formed in a plurality of leaves out of the four or more leaves at a plurality of corresponding sites along one side corresponding to one another among the plurality of leaves, wherein
the plurality of leaves are, on one common main surface, printed in an identical attitude among one another relative to the corresponding one side, and
the plurality of leaves are printed also on other common main surface, wherein
the printing on the one main surface of each of the plurality of leaves and the printing on the other main surface of a corresponding one of the plurality of leaves are identical to each other in an attitude, and
the leaves being separated along the perforations and being bound by a binder capable of opening and closing such that the one side is aligned with one another.

4. A leaf providing method, comprising:
manufacturing a rectangular sheet-like printed leaf having tear-off perforations formed vertically and horizontally so as to divide the entire printed leaf into four or more equal rectangular leaves, and binding holes formed in a plurality of leaves out of the four or more leaves at a plurality of corresponding sites along one side corresponding to one another among the plurality of leaves, wherein (i) the plurality of leaves are, on one common main surface, printed in an identical attitude among one another relative to the corresponding one side, and the plurality of leaves are printed also on other common main surface, and (ii) the printing on the one main surface of each of the plurality of leaves and the printing on the other main surface of a corresponding one of the plurality of leaves are identical to each other in an attitude;
separating each of the leaves from the printed leaf along the perforations;
stacking and packing the separated leaves; and
shipping the packed leaves to a customer.

5. The printed leaf according to claim 1, wherein:
the rectangular printed leaf is band-like,
the tear-off perforations include two or more perforations that extend in a short side direction of the band-like printed leaf and that are juxtaposed to each other in a long side direction of the band-like printed leaf, and
the printed leaf is zigzag-folded employing each of the two or more perforations juxtaposed to each other in the long side direction as a fold line.

6. A book into which a plurality of leaves are bound, wherein
at least one leaf out of the plurality of leaves includes a rectangular sheet-like printed leaf having tear-off perforations formed vertically and horizontally so as to divide the entire printed leaf into four or more equal rectangular leaves, and binding holes formed in a plurality of leaves out of the four or more leaves at a plurality of corresponding sites along one side corresponding to one another among the plurality of leaves, wherein (i) the plurality of leaves are, on one common main surface, printed in an identical attitude among one another relative to the corresponding one side, and the plurality of leaves are printed also on other common main surface, and (ii) the printing on the one main surface of each of the plurality of leaves and the printing on the other main surface of a corresponding one of the plurality of leaves are identical to each other in an attitude, and
the printed leaf is capable of being separated from the remainder of the book along tear-off perforations.

7. The book according to claim 6, wherein
the at least one leaf includes the printed leaf and a coupling region coupled to the printed leaf,
tear-off perforations are formed between the printed leaf and the coupling region, and
the at least one leaf is bound at the coupling region.

8. The book according to claim 6, wherein
other at least one leaf out of the plurality of leaves includes other rectangular sheet-like printed leaf capable of being separated along tear-off perforations, the other printed leaf includes:
tear-off perforations formed in one of a vertical manner, a horizontal manner, and a vertical and horizontal manner, so as to divide the entire other printed leaf into two or more equal rectangular leaves; and
binding holes formed in a plurality of leaves out of the two or more leaves at a plurality of corresponding sites along one side corresponding to one another among the plurality of leaves, wherein
the plurality of leaves out of the two or more leaves are, on one common main surface, printed in an identical attitude to one another relative to the corresponding one side,
the plurality of leaves out of the two or more leaves are printed also on other common main surface opposite to the one main surface printed, and
the printing on the one main surface of each of the plurality of leaves out of the two or more leaves and the printing on the opposite main surface of a corresponding one of the plurality of leaves out of the two or more leaves are identical to each other in attitude.

9. The book according to claim 6, wherein
other at least one leaf out of the plurality of leaves includes other rectangular sheet-like printed leaf capable of being separated along tear-off perforations,
binding holes are formed in the other printed leaf at a plurality of sites along one side, and
the other leaf are, on both main surfaces, printed in an identical attitude.

10. The book according to claim 8, wherein
the other at least one leaf includes the other printed leaf and other coupling region coupling to the other printed leaf,
tear-off perforations are formed between the other printed leaf and the other coupling region, and
the other at least one leaf is bound at the other coupling region.

11. A book into which a plurality of leaves are bound, wherein
at least one leaf out of the plurality of leaves includes a rectangular sheet-like printed leaf capable of being separated along tear-off perforations, the printed leaf includes:
tear-off perforations formed in one of a vertical manner, a horizontal manner, and a vertical and horizontal manner, so as to divide the entire printed leaf into two or more equal rectangular leaves; and
binding holes formed in a plurality of leaves out of the two or more leaves at a plurality of corresponding sites along one side corresponding to one another among the plurality of leaves, wherein
the plurality of leaves are, on one common main surface, printed in an identical attitude among one another relative to the one corresponding side,
the plurality of leaves are printed also on other common main surface, and
the printing on the one main surface of each of the plurality of leaves and the printing on the other main surface of a corresponding one of the plurality of leaves are identical to each other in an attitude.

12. The book according to claim 11, wherein
the printing on the one common main surface is a printed calendar, and
the printing on the other common main surface is an advertisement.

13. A book into which a plurality of leaves are bound, wherein
at least one leaf out of the plurality of leaves includes a rectangular sheet-like printed leaf capable of being separated along tear-off perforations,
binding holes are formed at the printed leaf in a plurality of sites along one side, and
the printed leaf is, on both main surfaces, printed in an identical attitude.

14. The book according to claim 11, wherein
the at least one leaf includes the printed leaf and a coupling region coupled to the printed leaf,
tear-off perforations are formed between the printed leaf and the coupling region, and
the at least one leaf is bound at the coupling region.

15. The book according to claim 13, wherein
the at least one leaf includes the printed leaf and a coupling region coupled to the printed leaf,
tear-off perforations are formed between the printed leaf and the coupling region, and
the at least one leaf is bound at the coupling region.

16. The book according to claim 9, wherein
the other at least one leaf includes the other printed leaf and other coupling region coupling to the other printed leaf,
tear-off perforations are formed between the other printed leaf and the other coupling region, and
the other at least one leaf is bound at the other coupling region.
